(19) United States
(12) Patent Application Publication
(10) Pub. No.: US 2026/0155109 A1
(43) Pub. Date: Jun. 4, 2026

(54) LED HYBRID DIMMING METHOD, DEVICE AND COMPUTER-READABLE STORAGE MEDIUM

(71) Applicant: SHENZHEN SUNMOON MICROELECTRONICS CO., LTD., Shenzhen (CN)

(72) Inventor: Keyong Chen, Shenzhen (CN)

(21) Appl. No.: 19/460,405

(22) Filed: Jan. 27, 2026

Related U.S. Application Data
(63) Continuation of application No. PCT/CN2024/094214, filed on May 20, 2024.

(30) Foreign Application Priority Data
Aug. 30, 2023 (CN) 202311100878.8

(51) Int. Cl. G09G 3/34; G09G 3/32; H05B 45/325

(52) U.S. Cl. CPC G09G 3/3406; G09G 3/32; H05B 45/325; G09G 2320/0271; G09G 2320/064

(57) ABSTRACT

The present application relates to a LED hybrid dimming method, device, and computer-readable storage medium. The LED hybrid dimming method comprises: S1. receiving grayscale data for display of a current frame and determining high gray data and low gray data; S2. maintaining a LED conduction current at a lowest current level and adjusting a PWM duty cycle through the low gray data to adjust LED brightness when the high gray data is 0; and S3. maintaining the PWM duty cycle at a maximum value of 1, determining two adjacent levels of LED conduction current through the high gray data, and adjusting time for switching the LED conduction current back and forth between the two adjacent levels through the low gray data when the high gray data is greater than 0. The LED hybrid dimming method and device of the present application can achieve linear grayscale adjustment under hybrid dimming.

### CROSS-REFERENCE TO RELATED APPLICATIONS

The present application is a continuation application of a PCT application No. PCT/CN2024/094214 filed on May 20, 2024, which claims the benefit of Chinese Patent Application No. 202311100878.8 filed on Aug. 30, 2023. All the above are hereby incorporated by reference.

### TECHNICAL FIELD

The present application relates to LED (light-emitting diode) display driving technology, and in particular, to a LED hybrid dimming method, device, and computer-readable storage medium.

### BACKGROUND

Liquid crystal displays (LCDs) have the advantages of low power consumption, small size, and no radiation, thus occupying an important position in the display market. A LCD display mainly comprises a LCD display panel, a driving circuits and a backlight module. The backlight module mainly provides backlight sources for the LCD display.

In recent years, due to the advantages of higher brightness and lower power consumption of LEDs, backlight modules using LEDs as light sources have attracted much attention. At present, a PWM (Pulse Width Modulation) dimming method is usually adopted for the adjustment of LED backlight brightness, which keeps the current passing through the LEDs constant, changes the PWM duty cycle, and controls the LED conduction time to achieve brightness adjustment. However, the PWM dimming method has the following drawbacks:

1. In the case of low grayscale values, a high refresh rate cannot be achieved. Due to changes in PWM duty cycle, LED flickering may occur, resulting in poor display performance.

2. In the case of high grayscale values, if the PWM frequency is exactly within a range of 100 Hz to 20 KHz human auditory frequency, the output capacitor will produce howling.

3. The PWM switching can easily bring power ripple interference.

To this end, hybrid dimming techniques have been proposed, which involves adjusting the PWM duty cycle and adjusting the conducting current for hybrid dimming. In the traditional hybrid dimming techniques, the input display data is divided into DC (Direct Current) data and PWM data. PWM data is used to control the conduction time, while DC data is used to control the current magnitude during conduction. As shown in FIG. 1, taking 6-bit DC data and 10-bit PWM data as an example, the current calculation formula is:

$${I}_{a r g} = ( DC data + 1 ) / 64 * {I}_{max} * PWM data / 1024 = {I}_{max} * ( DC data + 1 ) * PWM data / 65536$$

The current calculation formula is determined by both DC data and PWM data. To obtain a GAMMA table corresponding to the grayscale levels, complex calculations are required, and the calculated GAMMA is also nonlinear. Therefore, the traditional hybrid dimming techniques cannot achieve linear grayscale adjustment.

### SUMMARY

The technical problem to be solved by the present application is to provide a LED hybrid dimming method, device, and computer-readable storage medium that can achieve linear grayscale adjustment in response to the above-mentioned defects of the prior art.

According to a first aspect of the present application, a LED hybrid dimming method is provided, comprising the following steps:
S1. receiving grayscale data for display of a current frame and determining high gray data and low gray data;
S2. maintaining a LED conduction current at a lowest current level and adjusting a PWM duty cycle through the low gray data to adjust LED brightness when the high gray data is 0; and
S3. maintaining the PWM duty cycle at a maximum value of 1, determining two adjacent levels of LED conduction current through the high gray data, and adjusting time for switching the LED conduction current back and forth between the two adjacent levels through the low gray data when the high gray data is greater than 0.

In an embodiment of the LED hybrid dimming method according to the first aspect of the present application, step S2 further comprises: dividing a maximum LED conduction current Iₘₐₓ into 2^{a} levels based on a-bit high gray data, and the lowest current level is:

$$I = \frac{1}{{2}^{a}} \times {I}_{max} ,$$

wherein, I represents the lowest current level, Iₘₐₓ represents the maximum LED conduction current, and a represents a number of bits of the high gray data.

In an embodiment of the LED hybrid dimming method according to the first aspect of the present application, step S2 further comprises: adjusting the PWM duty cycle based on b-bit low gray data, that is, the PWM duty cycle=low gray data/2^{b}, wherein b represents a number of bits of the low gray data.

In an embodiment of the LED hybrid dimming method according to the first aspect of the present application, step S3 further comprises: determining the two adjacent levels of LED conduction current through the high gray data as follows:

$${I}_{h i g h} = \frac{( high gray data + 1 )}{{2}^{a}} \times {I}_{max} ,$$

$${I}_{low} = \frac{high gray data}{{2}^{a}} \times {I}_{max} ,$$

wherein, I_{high} and I_{low} respectively represent a higher current level and a lower current level of the two adjacent levels of LED conduction current, Iₘₐₓ represents the maximum LED conduction current, and a represents the number of bits of the high gray data.

In an embodiment of the LED hybrid dimming method according to the first aspect of the present application, in step S3, adjusting time for switching the LED conduction current back and forth between the two adjacent levels through the low gray data further comprises: breaking down the low gray data according to a refresh cycle, outputting the higher current level when the low gray data is present and outputting the lower current level when the low gray data is not present.

In an embodiment of the LED hybrid dimming method according to the first aspect of the present application, in step S3, adjusting time for switching the LED conduction current back and forth between the two adjacent levels through the low gray data further comprises: evenly distributing the low gray data to each refresh cycle, outputting the higher current level during a display clock time corresponding to the low gray data in each refresh cycle, and outputting the lower current level during the remaining time.

According to a second aspect of the present application, a LED hybrid dimming device is provided, comprising:
a data acquisition module, being configured to receive grayscale data for display of a current frame, and to determine high gray data and low gray data; and
a hybrid dimming module, being configured to maintain a LED conduction current at a lowest current level and adjust a PWM duty cycle through the low gray data to adjust LED brightness when the high gray data is 0, and further being configured to maintain the PWM duty cycle at a maximum value of 1, determine two adjacent levels of LED conduction current through the high gray data, and adjust time for switching the LED conduction current back and forth between the two adjacent levels through the low gray data when the high gray data is greater than 0.

According to a third aspect of the present application, a LED hybrid dimming device is provided, comprising a processor and a memory, wherein the memory stores a computer program, and the computer program, when executed by the processor, implements the steps of the LED hybrid dimming method as described above.

According to a fourth aspect of the present application, a computer-readable storage medium is provided, it stores a computer program that, when executed by a processor, implements the steps of the LED hybrid dimming method as described above.

Implementing the LED hybrid dimming method, device, and computer-readable storage medium of the present application has the following beneficial effects: the LED hybrid dimming method and device according to the embodiments of the present application adjust the LED conduction current level through high gray data and adjust the PWM duty cycle or the conduction current switching time through low gray data. This not only improves the refresh rate during low gray display and reduces the high current ripple of the power supply during high gray display, but also achieves linear grayscale adjustment under hybrid dimming.

### BRIEF DESCRIPTION OF THE DRAWINGS

The following will further explain the present application in conjunction with the accompanying drawings and embodiments. In the accompanying drawings:

FIG. 1 is a schematic diagram of a traditional hybrid dimming technology;

FIG. 2 is a basic schematic diagram of a LED hybrid dimming technology of the [0023] present application;

FIG. 3 is a flowchart of a LED hybrid dimming method according to an embodiment of the present application;

FIG. 4 is a schematic diagram of LED backlight brightness adjustment in a case of 6-bit high gray data and 10-bit low gray data with the high gray data being 0 in an embodiment of the present application;

FIG. 5 is a schematic diagram of LED backlight brightness adjustment in a case of 6-bit high gray data and 10-bit low gray data with the high gray data being greater than 0 in an embodiment of the present application;

FIG. 6 is a logic diagram of a LED hybrid dimming device according to an embodiment of the present application;

FIG. 7 is a logic diagram of a LED hybrid dimming device according to another embodiment of the present application.

### DETAILED DESCRIPTION

In order to make the purpose, technical solution, and advantages of this application clearer and more understandable, the following will provide further detailed explanations of this application in conjunction with the accompanying drawings and embodiments. It should be understood that the specific embodiments described herein are only used to explain the present application and are not intended to limit the present application. And, in the absence of conflicts, the embodiments and features in the embodiments of the present application can be combined with each other.

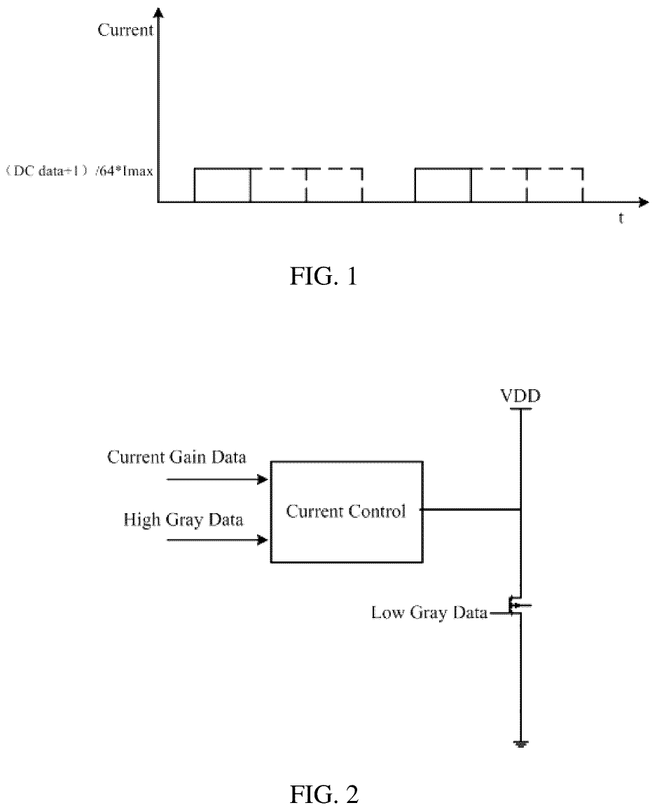

The present application proposes a LED hybrid dimming technology that achieves hybrid dimming by adjusting PWM duty cycle and conduction current. A basic principle is shown in FIG. 2, where the current gain data is used to adjust a maximum LED conduction current/max, the high gray data is used to adjust LED conduction current levels, and the low gray data is used to adjust a PWM duty cycle or a conduction current switching time.

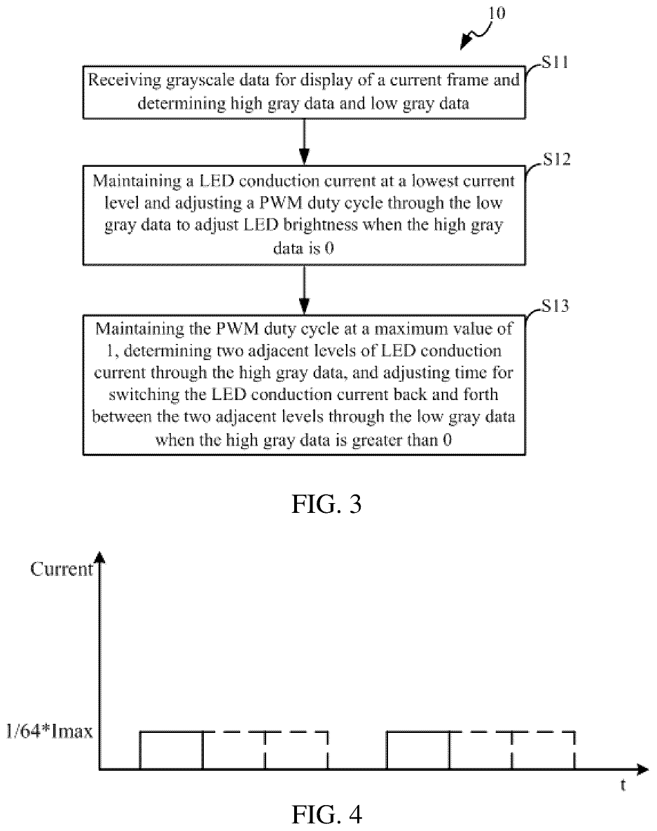

Based on the above basic principle, the present application proposes a LED hybrid dimming method. FIG. 3 shows a flowchart of a LED hybrid dimming method 10 according to an embodiment of the present application. As shown in FIG. 3, the LED hybrid dimming method 10 comprises the following steps:

In step S11, grayscale data G for display of a current frame is received, and high gray data and low gray data are determined.

In step S12, when the high gray data is 0, a LED conduction current is maintained at a lowest current level, and a PWM duty cycle is adjusted through the low gray data to adjust LED brightness. In a specific embodiment, the LED hybrid dimming method 10 divides a maximum LED conduction current Iₘₐₓ into 2^{a} levels based on a-bit high gray data, and the lowest current level is:

$$I = \frac{1}{{2}^{a}} \times {I}_{max} ,$$

wherein, I represents the lowest current level, Iₘₐₓ represents the maximum LED conduction current, and a represents a number of bits of the high gray data. If the low gray data consists of b bits, the PWM duty cycle is adjusted based on the b bits of low gray data, that is, the PWM duty cycle=low gray data/2^{b}, wherein b represents a number of bits of the low gray data.

In step S13, when the high gray data is greater than 0, the PWM duty cycle is maintained at a maximum value of 1, two adjacent levels of LED conduction current are determined through the high gray data, and time for switching the LED conduction current back and forth between the two adjacent levels is adjusted through the low gray data. In a specific embodiment, the LED hybrid dimming method 10 determines the two adjacent levels of LED conduction current through the high gray data as follows:

$${I}_{h i g h} = \frac{( high gray data + 1 )}{{2}^{a}} \times {I}_{max} ,$$

$${I}_{low} = \frac{high gray data}{{2}^{a}} \times {I}_{max} ,$$

wherein, I_{high} and I_{low} respectively represent a higher current level and a lower current level of the two adjacent levels of LED conduction current, Iₘₐₓ represents the maximum LED conduction current, and a represents the number of bits of the high gray data. A specific switching manner used in the step S13 to adjust time for switching the LED conduction current back and forth between the two adjacent levels through the low gray data is: breaking down the low gray data according to a refresh cycle, outputting the higher current level when the low gray data is present and outputting the lower current level when the low gray data is not present. For example, the low gray data can be evenly distributed to each refresh cycle, and the higher current level is output during a display clock time corresponding to the low gray data in each refresh cycle, while the lower current level is output during the remaining time.

The following will take 6-bit high gray data and 10-bit low gray data as an example to illustrate how the LED hybrid dimming method 10 of the above embodiment of the present application adjusts LED backlight brightness. The high gray data comprises 6 bits, that means the maximum LED conduction current is divided into 64 levels. The low gray data comprises 10 bits, that means the PWM is divided into 1024 pieces.

As shown in FIG. 4, if the high gray data is 0, the LED conduction current is kept at the lowest current level, which is: 1=1/64*Iₘₐₓ. The PWM duty cycle is adjusted through the low gray data, therefore an average current flowing through the LED for the current frame is:

$${I}_{arg} = low gray data / 1024 * I .$$

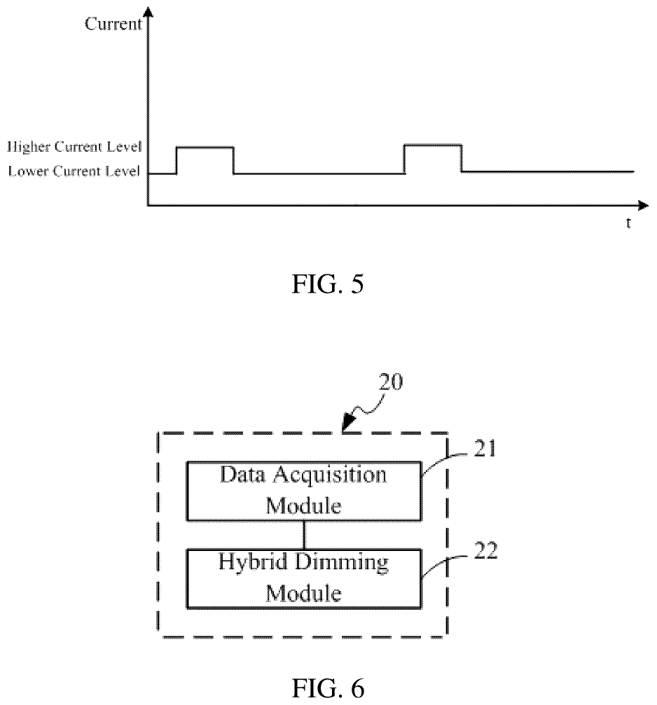

As shown in FIG. 5, if the high gray data is greater than 0, the PWM duty cycle is maintained at the maximum value of 1. The two adjacent levels of LED conduction current determined by the high gray data are:

$${I}_{h i g h} = \frac{( high gray data + 1 )}{{2}^{a}} \times {I}_{max} ,$$

$${I}_{low} = \frac{high gray data}{{2}^{a}} \times {I}_{max} .$$

The conduction current is adjusted to switch back and forth between the two adjacent levels through the low gray data, thus the average current flowing through the LED for the current frame is:

$${I}_{a r g} = ( low gray data / 1024 * {I}_{h i g h} ) + ( ( 1024 - low gray data ) / 1024 * {I}_{low} )$$

As mentioned earlier, a switching manner for the conduction current levels can be achieved by breaking down the low gray data according to the refresh cycle, outputting the higher current level when the low gray data is present, and outputting the lower current level when the low gray data is not present. That is, the low gray data controls a duty cycle of duration of the higher current level (the lower current level is output during the remaining time). To ensure display quality, the duration of the higher current level can be evenly distributed to each refresh cycle. For example, when the high gray data is 4 and the low gray data is 32, that is, when the display data (4*1024+32)=4128, the higher current level is (4+1)/64*Iₘₐₓ and the lower current level is 4/64*Iₘₐₓ. At this time, the duration of the higher current level is controlled by the low gray data. If the refresh cycle is 16 and there are 64 display clocks in each cycle, then there are 32/16=2 display clocks in each cycle for the higher current level, and the remaining time of (64−2)=62 display clocks are for the lower current level.

The above LED hybrid dimming technology can achieve linear grayscale adjustment. Assuming the grayscale data for display is G, Data_dc is the high 6 bits, and Data_pwm is the low 10 bits, a calculation is as follows:

(1) If Data_dc=0, then Data_pwm is the PWM duty cycle data, and a current I_{dc}=Iₘₐₓ/64, then the average current is:

$${I}_{arg} = {I}_{dc} * Data\_pwm / 1024 = {I}_{max} / 64 * Data\_pwm / 1024 = {I}_{max} * Data\_pwm / 65536$$

Since Data_dc=0 and Data_pwm is the lower 10 bits of G, then G=Data_pwm. Therefore, the calculated formula satisfies a theoretical current value:

$${I}_{arg} = {I}_{max} * G / 65536$$

(2) If Data_dc>0, then data of Data_pwm is the time duty cycle for selecting the DC current level as Data_dc, and for the remaining time, the current level is selected as Data_dc−1. At this point, the average current is:

$$\begin{matrix}{I}_{arg} = ( {I}_{max} * ( Data\_dc + 1 ) / 64 * Data\_pwm / 1024 ) + \\ ( {I}_{max} * Data\_dc / 64 * ( 1024 - Data\_pwm ) / 1024 ) \\ = {I}_{max} * ( ( Data\_dc + 1 ) * Data\_pwn + Data\_dc * \\ ( 1024 - Data\_pwm ) ) / 65536 \\ = {I}_{max} * ( Data\_pwm + Data\_dc * 1024 ) / 65536\end{matrix}$$

Since Data_dc is the high 6 bits of G and Data_pwm is the low 10 bits of G, then G=Data_pwm+Data_dc*1024. Therefore, the theoretical current formula is satisfied:

$${I}_{arg} = {I}_{max} * G / 65536$$

Comparison between the average current and the theoretical current of the LED hybrid dimming method according to the above embodiments of the present application is as follows:

If Iₘₐₓ is set to 64 mA and the grayscale data for display G is 512, then the high gray data is 0 and the low gray data is 512. Therefore, the average current is:

$${I}_{arg} = low gray data / 1024 * I = 512 / 1024 * 1 / 64 * 64 mA = 0.5 mA$$

The theoretical current is:

$${I}_{arg} = {I}_{max} * G / 65536 = 64 * 512 / 65536 = 0.5 mA$$

If the grayscale data for display G is 4096, then the high gray data is 4 and the low gray data is 0. Therefore, the average current is:

$$\begin{matrix}{I}_{arg} = ( low gray data / 1024 * {I}_{high} ) + ( ( 1024 - low gray data ) / 1024 * {I}_{low} ) \\ = ( 0 / 1024 * ( 4 + 1 ) / 64 * 64 mA ) + ( ( 1024 - 0 ) / 1024 * 4 / 64 * 64 mA ) \\ = 4 mA\end{matrix}$$

The theoretical current is:

$${I}_{arg} = {I}_{max} * G / 65536 = 64 * 4096 / 65536 = 4 mA$$

If the grayscale data for display G is 4608, then the high gray data is 4, and the low gray data is 512. Therefore, the average current is:

$$\begin{matrix}{I}_{arg} = ( low gray data / 1024 * {I}_{high} ) + ( ( 1024 - low gray data ) / 1024 * {I}_{low} ) \\ = ( 512 / 1024 * ( 4 + 1 ) / 64 * 64 mA ) + \\ ( ( 1024 - 512 ) / 1024 * 4 / 64 * 64 mA ) \\ = 4 \text{.5} mA\end{matrix}$$

The theoretical current is:

$${I}_{arg} = {I}_{max} * G / 65536 = 64 * 4608 / 65536 = 4.5 mA$$

In summary, the theoretical current and the actual current calculation results are consistent, indicating the correctness of the theoretical current I_{arg}=Iₘₐₓ*G/65536 in the LED hybrid dimming method proposed in the above embodiments of the present application, and the method can be used to achieve linear grayscale adjustment under hybrid dimming.

Based on the above LED hybrid dimming method, the present application also proposes a LED hybrid dimming device. FIG. 6 shows a logic diagram of a LED hybrid dimming device 20 according to an embodiment of the present application. As shown in FIG. 6, the LED hybrid dimming device 20 comprises a data acquisition module 21 and a hybrid dimming module 22. The data acquisition module 21 is configured to receive grayscale data for display of a current frame, and to determine high gray data and low gray data. The hybrid dimming module 22 is configured to maintain a LED conduction current at a lowest current level and adjust a PWM duty cycle through the low gray data to adjust LED brightness when the high gray data is 0. The hybrid dimming module 22 is further configured to maintain the PWM duty cycle at a maximum value of 1, determine two adjacent levels of LED conduction current through the high gray data, and adjust time for switching the LED conduction current back and forth between the two adjacent levels through the low gray data when the high gray data is greater than 0.

For further specific implementation of each module of the LED hybrid dimming device 20, please refer to the detailed description of each step of the LED hybrid dimming method 10 mentioned above.

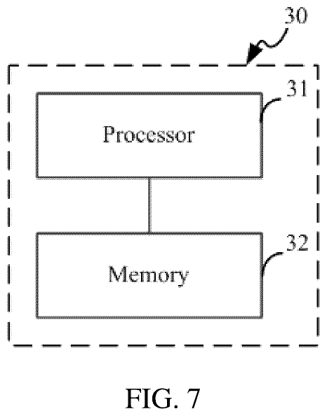

FIG. 7 shows a logical structure diagram of a LED hybrid dimming device 30 according to another embodiment of the present application. As shown in FIG. 7, the LED hybrid dimming device 30 comprises a processor 31 and a memory 32, which are connected in communication. The memory 32 stores a computer program that, when executed by the processor 31, causes the processor 31 to implement the steps of the LED hybrid dimming method 10 of the aforementioned embodiments of the present application.

The present application also proposes a computer-readable storage medium storing a computer program that, when executed by a processor, implements the steps of the LED hybrid dimming method 10 of the aforementioned embodiments of the present application.

The above description is only the preferred embodiments of the present application and is not intended to limit the present application. Any modifications, equivalent substitutions, and improvements made within the spirit and principles of the present application should be included within the scope of protection of the present application.

1. A LED hybrid dimming method, characterized in that said method comprises the following steps:
S1. receiving grayscale data for display of a current frame and determining high gray data and low gray data;
S2. maintaining a LED conduction current at a lowest current level and adjusting a PWM duty cycle through the low gray data to adjust LED brightness when the high gray data is 0; and
S3. maintaining the PWM duty cycle at a maximum value of 1, determining two adjacent levels of LED conduction current through the high gray data, and adjusting time for switching the LED conduction current back and forth between the two adjacent levels through the low gray data when the high gray data is greater than 0.

2. The LED hybrid dimming method according to claim 1, characterized in that step S2 further comprises: dividing a maximum LED conduction current Iₘₐₓ into 2^{a} levels based on a-bit high gray data, and the lowest current level is:
$$I = \frac{1}{{2}^{a}} \times {I}_{max} ,$$
wherein, I represents the lowest current level, Iₘₐₓ represents the maximum LED conduction current, and a represents a number of bits of the high gray data.

3. The LED hybrid dimming method according to claim 2, characterized in that step S2 further comprises: adjusting the PWM duty cycle based on b-bit low gray data, that is, the PWM duty cycle=low gray data/2^{b}, wherein b represents a number of bits of the low gray data.

4. The LED hybrid dimming method according to claim 1, characterized in that step S3 further comprises: determining the two adjacent levels of LED conduction current through the high gray data as follows:
$${I}_{high} = \frac{( high gray data + 1 )}{{2}^{a}} \times {I}_{max} ,$$
$${I}_{low} = \frac{high gray data}{{2}^{a}} \times {I}_{max} ,$$
wherein, I_{high} and I_{low} respectively represent a higher current level and a lower current level of the two adjacent levels of LED conduction current, Iₘₐₓ represents the maximum LED conduction current, and a represents the number of bits of the high gray data.

5. The LED hybrid dimming method according to claim 4, characterized in that in step S3, adjusting time for switching the LED conduction current back and forth between the two adjacent levels through the low gray data further comprises: breaking down the low gray data according to a refresh cycle, outputting the higher current level when the low gray data is present and outputting the lower current level when the low gray data is not present.

6. The LED hybrid dimming method according to claim 5, characterized in that in step S3, adjusting time for switching the LED conduction current back and forth between the two adjacent levels through the low gray data further comprises: evenly distributing the low gray data to each refresh cycle, outputting the higher current level during a display clock time corresponding to the low gray data in each refresh cycle, and outputting the lower current level during the remaining time.

7. A LED hybrid dimming device, characterized in that said device comprises:
a data acquisition module, being configured to receive grayscale data for display of a current frame, and to determine high gray data and low gray data; and
a hybrid dimming module, being configured to maintain a LED conduction current at a lowest current level and adjust a PWM duty cycle through the low gray data to adjust LED brightness when the high gray data is 0, and further being configured to maintain the PWM duty cycle at a maximum value of 1, determine two adjacent levels of LED conduction current through the high gray data, and adjust time for switching the LED conduction current back and forth between the two adjacent levels through the low gray data when the high gray data is greater than 0.

8. The LED hybrid dimming device according to claim 7, characterized in that when the high gray data is 0, the hybrid dimming module is further configured to divide a maximum LED conduction current Iₘₐₓ into 2^{a} levels based on a-bit high gray data, and the lowest current level is:
$$I = \frac{1}{{2}^{a}} \times {I}_{max} ,$$
wherein, I represents the lowest current level, Iₘₐₓ represents the maximum LED conduction current, and a represents a number of bits of the high gray data.

9. The LED hybrid dimming device according to claim 8, characterized in that when the high gray data is 0, the hybrid dimming module is further configured to adjust the PWM duty cycle based on b-bit low gray data, that is, the PWM duty cycle=low gray data/2^{b}, wherein b represents a number of bits of the low gray data.

10. The LED hybrid dimming device according to claim 7, characterized in that when the high gray data is greater than 0, the hybrid dimming module is further configured to determine the two adjacent levels of LED conduction current through the high gray data as follows:
$${I}_{high} = \frac{( high gray data + 1 )}{{2}^{a}} \times {I}_{max} ,$$
$${I}_{low} = \frac{high gray data}{{2}^{a}} \times {I}_{max} ,$$
wherein, I_{high} and I_{low} respectively represent a higher current level and a lower current level of the two adjacent levels of LED conduction current, Iₘₐₓ represents the maximum LED conduction current, and a represents the number of bits of the high gray data.

11. The LED hybrid dimming device according to claim 10, characterized in that when the high gray data is greater than 0, the hybrid dimming module being configured to adjust time for switching the LED conduction current back and forth between the two adjacent levels through the low gray data further comprises: evenly distributing the low gray data to each refresh cycle, outputting the higher current level during a display clock time corresponding to the low gray data in each refresh cycle, and outputting the lower current level during the remaining time.

12. A LED hybrid dimming device, characterized in that said device comprises a processor and a memory, wherein the memory stores a computer program, and the computer program, when executed by the processor, implements the steps of the LED hybrid dimming method according claim 1.

13. A computer-readable storage medium, characterized in that it stores a computer program that, when executed by a processor, implements the steps of the LED hybrid dimming method according to claim 1.
